(19) United States
(12) Patent Application Publication
(10) Pub. No.: US 2026/0171061 A1
(43) Pub. Date: Jun. 18, 2026

(54) SPRAYABLE AQUEOUS ACOUSTIC DAMPING COMPOSITIONS, AND ARTICLES THEREFROM

(71) Applicant: Henkel AG & Co. KGaA, Duesseldorf (DE)

(72) Inventors: Yalong Qi, Shanghai (CN); Hongyu Chu, Shanghai (CN)

(21) Appl. No.: 19/534,916

(22) Filed: Feb. 10, 2026

Related U.S. Application Data
(63) Continuation of application No. PCT/CN2023/116077, filed on Aug. 31, 2023.

(51) Int. Cl. G10K 11/165; B60R 13/08

(52) U.S. Cl. CPC G10K 11/165; B60R 13/08

(57) ABSTRACT

The invention relates to a sprayable aqueous acoustic damping composition comprising a polymer, a filler, and a water-soluble cellulose compound or a water-soluble starch, wherein, the filler comprises a filler (i) with an average particle size (d₅₀ particle size) of about 7-18 μm and a filler (ii) with an average particle size (d₅₀ particle size) of about 2-5 μm.

### TECHNICAL FIELD

The present disclosure relates to sprayable aqueous acoustic damping compositions for motor vehicle applications, articles therefrom, especially an aqueous acoustic damping composition with good anti-crack property. The aqueous acoustic damping compositions can be used, for example, in automotive industrial applications.

### BACKGROUND OF THE INVENTION

Acoustic damping materials, such as manual applied sound deadening patches using asphalt pads, have been facilitated in various industrial appliances and vehicles to suppress the noise caused by vibration. To save labor during installation and replacement, sprayable polymer based acoustic damping compositions, also known as liquid-applied acoustic damping (LASD) materials, have been developed accordingly. Possessing a higher damping efficiency and better odor, LASD offers a reduced application amount and a facile application through robotic controlled applicator guns, which is more compatible to automatic, light-weighted, and environmentally friendly design.

LASD compositions can be characterized as either aqueous or non-aqueous systems. In comparison to non-aqueous LASD coatings, aqueous systems have undoubted advantages such as easier design, wider damping range, less VOC emission, and lower cost. However, their drying performance in bakeable or air-dried conditions may often lead to large blisters and cracks. Adding fiber additive could improve the crack issue, but the spray nozzle gets clogged easily, then will increase difficulty in operating and production cost.

Thus, the development of aqueous LASD composition with good acoustic performance and good anti-crack property and good operability performance, especially at room temperature, is demanding.

### SUMMARY OF THE INVENTION

It is therefore the object of the present invention to overcome the above-mentioned drawbacks by providing a sprayable aqueous LASD composition with both good anti-crack performance and good operability performance.

It has been surprisingly found that aqueous acoustic damping composition prepared from a curable aqueous composition comprising at least a polymer; at least a filler; a water-soluble cellulose compound or a water-soluble starch, which provides both good anti-crack performance and good operability performance. Under room temperature or after pre-heating, the aqueous acoustic damping compositions of present invention are easy to spray (especially flat spray) by hand or automatically to form a coating without any cracks, and blockage problem of the spraying nozzle can be improved. Even more, some of the aqueous acoustic damping compositions in present invention does not need additional heating and can be easily incorporated into an automatic spray production line at room temperature. In addition, some of the aqueous acoustic damping compositions in present invention have high thixotropic index and produced LASD products have special surface texture. Meanwhile this LASD composition could provide a good acoustic damping performance. The aqueous acoustic damping compositions can be applied and cured at room temperature, for example, can be used in automotive industrial applications, especially in vehicle repair applications.

According to one aspect, the present invention relates to a sprayable aqueous acoustic damping composition comprises: a) 0.1-0.75 parts by weight of a water-soluble cellulose compound or a water-soluble starch, b) 10 to 35 parts by weight of a polymer, c) 15 to 30 parts by weight of water; d) 20 to 45 parts by weight of a filler; wherein, the filler comprising a filler (i) with an average particle size (d₅₀ particle size) of about 7-18 μm and a filler (ii) with an average particle size (d₅₀ particle size) of about 2-5 μm.

In another aspect, the present invention provides a use of the sprayable aqueous acoustic damping composition according to present invention as a liquid applied sound damping composition.

In still another aspect, the present invention provides an article including an aqueous acoustic damping composition on a surface of the article, wherein the aqueous acoustic damping composition is a cured product of the sprayable aqueous acoustic damping composition of present invention.

In still another aspect, the present invention provides a method of preparing a coated substrate, said method comprising:
a) applying a sprayable aqueous acoustic damping composition as defined in present invention to at least a surface of a substrate by spraying; and,
b) curing the composition at 10-50° C. preferably at 20-30° C.

In still another aspect, the present invention relates to a vehicle component obtained by the method as defined in present invention.

Further objects and advantages of this invention will be apparent from the following detailed description and examples of a presently preferred embodiment.

### BRIEF DESCRIPTION OF THE DRAWINGS

FIG. 1 shows the appearance of cured compositions of the sprayable aqueous acoustic damping composition of E1 and CE4.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The term “polymer” is used herein consistent with its common usage in chemistry. Polymers are composed of many repeated subunits. The term “polymer” is used to describe the resultant material formed from a polymerization reaction.

The term “acrylic” refers to both or any one of “acrylic” and “methacrylic”.

The term “acrylate” refers to both or any one of “acrylate” and “methacrylate”.

The term “curing” means a process of hardening of a material. The term is intended to encompass the drying of the material through the evaporation of water and co-solvents from the material and also, where applicable, the cross-linking of components within the material which possess reactive groups.

As used herein, “Mw” refers to the weight average molecular weight and means the theoretical value as determined by Gel Permeation Chromatography (GPC) relative to linear polystyrene standards of 1.1 M to 580 Da and may be performed using Waters 2695 separation module with a Waters 2414 differential refractometer (RI detector). “Mn” refers to the number average molecular weight and means the theoretical value as determined by Gel Permeation Chromatography (GPC) too.

As used herein, the glass transition temperature (Tg) is determined by differential scanning calorimetry (DSC) employing a 20 K/min ramp rate and midpoint measurement in accordance with DIN 53 765.

As used herein, by “D₅₀ particle size” is meant that the particle size distribution is such that at least 50% of the particles by weight have a particle size diameter of less than the specified value. Unless otherwise stated, that particle size is determined by laser diffraction.

As used herein, the thixotropic index (TI) is a measure of the shear-dependent properties and can be defined as the ratio of viscosities measured at a certain lower rpm (or low shear rate) to viscosities measured at a certain higher rpm (or high shear rate).

The term “water-soluble” means that the relevant component or ingredient of the composition can be dissolved in the aqueous phase on the molecular level.

Unless specified otherwise, the recitation of numerical end points includes all numbers and fractions subsumed within the respective ranges, as well as the recited end points.

All percentages given herein in relation to the compositions or formulations relate to weight % relative to the total weight of the respective composition or formula, if not explicitly stated otherwise.

Unless otherwise defined, all terms used in disclosing the invention, including technical and scientific terms, have the meaning as commonly understood by one of the ordinary skills in the art to which this invention belongs to. By means of further guidance, term definitions are included to better appreciate the teaching of the present invention.

As discussed previously, embodiments of the present disclosure are directed to a sprayable aqueous acoustic damping composition comprising at least a polymer; at least a filler; at least a water-soluble cellulose compound. The sprayable aqueous acoustic damping composition further comprises a defoaming agent, and/or a filler, and/or a diluent, and/or a bactericide. And the liquid phase of the sprayable aqueous acoustic damping composition includes water.

### Polymer

Present invention comprises one or more polymer in particulate “water-based resin” or “water-based polymer resin”.

As used herein, the terms “water-based polymer”, “water-based resin”, or “water-based polymer resin” refer to polymeric materials that are combined with water and/or polymeric materials that are formed by polymerizing their constituent monomers in a water medium. Water-based resins include but are not limited to latexes, emulsions, water-reducible dispersions, and solutions of a polymer or polymer blends in water.

Suitable water-based resins comprise any polymers made from any possible monomer combinations, and mixtures thereof, including but not limited to acrylic polymer (including co-polymer) latexes, styrene-acrylic copolymer emulsions, styrene-butadiene copolymer latexes, vinyl acetate emulsions (including but not limited to polyvinyl acetate (“PVAc”) emulsions and ethylene vinyl acetate (“EVA”) copolymer emulsions), vinyl-acrylic copolymer emulsions and the like. Preferred water-based resins include styrene-butadiene emulsions, acrylic emulsions, acrylic ester emulsions, ethylene-vinyl acetate emulsions, and mixtures thereof.

The acrylic emulsions suitable for present invention are in dispersed (emulsified) form and may be selected from any of the acrylic polymeric materials conventionally used in aqueous compositions capable of forming vibration and/or damping coatings on substrate surfaces. Preferred acrylic polymers include dispersions of acrylate polymers and copolymers (sometimes referred to in the art as acrylic resins) such as, for example, copolymers of lower alkyl (meth)acrylates such as n-butyl acrylate with comonomers such as styrene and/or acrylonitrile are also preferred for use. Mixtures of the aforedescribed polymers may be used and may be preferred for purposes of obtaining the desired combination of properties in the final cured compositions. For example, different polymers having different glass transition temperature characteristics may be used in combination. Generally speaking, the polymers used in the present invention typically have glass transition temperatures in the range of from about −10° C. to about 40° C., preferably 0° C. to 20° C. However, in one embodiment of the invention a combination of polymers is used wherein one polymer has a Tg greater than 0° C. (e.g., 5 to 35° C.) and another polymer is elastomeric and has a Tg less than 0° C. (e.g., −10 to −30° C.). The two polymers may, for example, both be acrylic resins having different monomer compositions selected to provide the desired Tg characteristics.

According to the invention, acrylic polymer emulsions are generally obtained with a solids content of greater than 45% by weight, preferably greater than 50%. In some embodiments of the present invention, the solid content of the acrylic polymer in the composition is from 10 to 40 parts by weight, or from 10 to 35 parts by weight, or from 20 to 30 parts by weight. Further, the acrylic polymer emulsion should be obtained with a mono-modal particle size distribution characterized in that the average particle size (d₅₀) of the polymer particles in the aqueous dispersion is from 50 to 400 nm, for example from 50 to 200 nm.

Suitable water-based resins also include styrene-butadiene copolymer latexes having a glass transition temperature of from about −20° C. to about 50° C. The solids content of the styrene-butadiene latex ranges generally from about 45 percent to about 65 percent, with a solids content of from about 48 percent to about 58 percent being preferred. One exemplary styrene-butadiene latex is GenCal 7463, a product of Omnova Solutions, Inc. of Fairlawn Ohio. GenCal 7463 is a modified styrene/butadiene latex with a solid percent of about 53 percent. Another exemplary styrene-butadiene copolymer latex is Styronal ND 656, a product of BASF Corporation. Styronal ND 656 is a carboxylated styrene/butadiene dispersion that has a solids content of from about 49 percent to about 51 percent and which forms films with a glass transition temperature of about 18° C. When styrene-butadiene water-based resins are used to form the sprayable aqueous acoustic damping composition, the resin is preferably added in an amount (i.e., including both the solid and water phase) that is generally from about 15 percent to about 65 percent by weight of the total damping composition, with amounts ranging from about 15 percent to about 30 percent being preferred, and amounts ranging from about 20 percent to about 25 percent being especially preferred.

Suitable EVA water-based resins include those having EVA copolymer latexes with a glass transition temperature of from about −20° C. to about 50° C. The EVA latex preferably has a percent solid ranging from about 45 percent to about 70 percent by weight, with a solids content of from about 50 percent to about 65 percent by weight being preferred. When EVA latexes are used to form the sprayable aqueous acoustic damping composition, they are preferably added in an amount (including both resin and the water phase) ranging from about 10 percent to about 30 percent by weight of the total damping composition, with EVA latex amounts ranging from about 15 percent to about 25 percent being preferred.

### Filler

Present invention comprises one or more inorganic fillers in particulate form being incorporated into the aqueous compositions for the purpose of providing bulk to the dried coating, adjusting the hardness of the dried coating, improving the sound or vibration damping properties of the dried coating, controlling blistering of the dried coating, and/or modifying the flammability of the dried coating, among other purposes. The inorganic filler(s) may be in any suitable form such as powder, needle-like, scale-like, spherical, plate-like, and other shapes known in the art and should be insoluble in water. The surface of fillers can be either coated with hydrophilic/hydrophobic small molecules/polymer or without any modification. Examples of inorganic fillers suitable for use include, but are not limited to, calcium carbonate, alumina, aluminum hydroxide, perlite, barium sulfate, magnesium carbonate, calcium dihydrate, rock wool, asbestos, wollastonite, zeolite, glass or ceramic microspheres, graphite, and the like and mixtures thereof. Preferred inorganic fillers include calcium carbonate, barium sulfate, zinc oxide, aluminum oxide, titanium dioxide, aluminum hydroxide, talcum powder or any combination thereof.

The inorganic filler comprises a filler (i) with an average particle size (D₅₀ particle size) of about 7-18 μm and a filler (ii) with an average particle size (D₅₀ particle size) of about 2-5 μm.

The inorganic filler (i) is characterized by an average particle diameter (D₅₀) of from about 7 to 18 μm, preferably 7 to 15 μm, or 10 to 12 μm. The amount of inorganic filler (i) in the composition is particularly at least 15 parts by weight, or at least 18 parts by weight, or at least 20 parts by weight, or at least 22 parts by weight, or at least 25 parts by weight, or at least at least 30 parts by weight of particulate filler of the composition.

The inorganic filler (ii) is characterized by an average particle diameter (D₅₀) of from about 2 to 5 μm, or 2.5 to 5 μm, or 3 to 5 μm. The amount of inorganic filler (ii) in the composition is particularly at least 3 parts by weight, or at least 5 parts by weight, or at least 10 parts by weight, or at least 12 parts by weight, or at least 15 parts by weight, of particulate filler of the composition.

The weight ratio of the filler (i) to the filler (ii) is from 1.9:1 to 4:1, or from 2.0:1 to 3.5:1, or from 2.0:1 to 3.2:1, or from 2.0:1 to 2.9:1.

### Water-Soluble Cellulose Compound

Present invention comprises water-soluble cellulose compounds or a water-soluble starch, the water-soluble cellulose compounds include water-soluble cellulose derivatives. The water-soluble cellulose derivatives include but not limited to water-soluble cellulose ether, water-soluble cellulose salts. It was found surprisingly, the compositions of present invention using a water-soluble cellulose ether and/or water-soluble cellulose salt in conjunction with filler (i) and filler (ii) have good anti-cracking performance and high thixotropic index.

Some water-soluble polysaccharides, such as xanthan gum, are not suitable for present invention. Some insoluble polysaccharides, such as insoluble starch, are not suitable for present invention, either.

In some embodiments, the water-soluble starch, water-soluble cellulose salt, or water-soluble cellulose ether is supplied as a dried powder. Suitable water-soluble cellulose ether powder, cellulose salt powder and water-soluble starch powder include but are not limited to Natrosol 250 HHR and Natrosol 250 LR, which are supplied by Ashland Inc, and CMC 75 A Powder, which is supplied by Mikro-Technik GmbH & Co. KG.

Without wishing to be bound by any theory, it is believed that the addition of water-soluble starch, and/or cellulose salts, and/or cellulose ethers to the damping compositions described herein produces hydrogen bonding between the resin, filler, and water, which avoid the phase separation occurred during heating or drying processes and improve the cracking after drying. In some exemplary embodiments, the amount of water-soluble starch, and/or cellulose salts, and/or cellulose ethers added to the damping composition is about 0.1 parts by weight to about 0.75 parts by weight in the total damping composition. 0.2 parts by weight to about 0.5 parts by weight, or 0.25 parts by weight to about 0.4 parts by weight, is preferred. In some embodiments, the amount of water-soluble cellulose ethers, and/or cellulose salts added to the damping composition is at most 0.9 parts by weight, or at most 0.8 parts by weight, or at most 0.75 parts by weight, or at most 0.6 parts by weight, or at most 0.5 parts by weight. An access amount of water-soluble cellulose ethers, and/or cellulose salts, for example more than 0.9 parts by weight, or more than 1.0 parts by weight, or more than 1.2 parts by weight, or more than 1.5 parts by weight, can cause gelation or block the spray nozzle with a composition that is too thick (viscosity is too high) for flat spraying.

### Other Compounds

The sprayable aqueous acoustic damping composition may contain, if necessary, various additives, in a range that does not inhibit the object of the present technology, such as defoaming agents, fillers, diluents, bactericides, pigments (dyes). By the addition of such fillers/additives, physical properties such as rheological properties, viscosity, flow rate, antibacterial property, and the like can be modified to desired values.

In some embodiments of present invention, the composition further comprises from 0.02 to 2 parts by weight of a defoamer.

In some embodiments of present invention, the composition further comprises from 5 to 11 parts by weight, or 5-10 parts by weight of a mica.

In some embodiments of present invention, the composition doesn't comprise fumed silica as thixotropic agent.

The sprayable aqueous acoustic damping composition of the present invention comprises water as solvent to dissolve all components to form the sealing solution. In some embodiments of the present invention, it is preferable to use deionized water as solvent. In some embodiments of present invention, the water content being 20-30 parts by weight in the composition.

### Preparing Method of the Sprayable Aqueous Acoustic Damping Compositions

The sprayable aqueous acoustic damping compositions are formulated by simple mixing of the various components.

In some embodiments, the sprayable aqueous acoustic damping composition comprises from 15.0 to 30.0 parts by weight of water as a liquid phase.

Without specific intention to limit the amount of water included in the aqueous compositions, it is preferred that said compositions contain from 15 to 30 wt. %, preferably from 20 to 30 wt. % of water, based on the weight of the composition.

### Application Method of the Sprayable Aqueous Acoustic Damping Compositions

In accordance with the broadest process aspects of the present invention, the above-described compositions are applied to a substrate and then cured in situ.

There is no particular intention to limit the substrates to which the present compositions may be applied. In application to vehicular panels, exemplary substrates may be metallic, polymeric or combinations thereof. However, particular mention may be made of: ferrous metals, such as iron, steel, and alloys thereof; nonferrous metals, such as aluminum, zinc and alloys thereof; and combinations thereof. In illustrative embodiments, the substrate may be formed from: cold rolled steel; electro-galvanized steel, such as hot dip electro-galvanized steel or electro-galvanized iron-zinc steel; or aluminum.

Prior to applying the compositions, it is often advisable to pre-treat the relevant surfaces to remove foreign matter there from: this step can, if applicable, facilitate the subsequent adhesion of the compositions thereto. Such treatments are known in the art and can be performed in a single or multi-stage manner constituted by, for instance, immersion in a waterborne alkaline degreasing bath; treatment with a waterborne cleaning emulsion; treatment with a cleaning solvent, such as carbon tetrachloride or trichloroethylene; and, water rinsing, preferably with deionized or demineralized water. In those instances where a waterborne alkaline degreasing bath is used, any of the degreasing agent remaining on the surface should desirably be removed by rinsing the substrate surface with deionized or demineralized water.

The compositions are then applied to the preferably pre-treated, optionally primed surfaces of the substrate by spraying methods, including but not limited to air-atomized spray, air-assisted spray, airless spray and high-volume low-pressure spray.

The thickness of the applied coating in the present invention may be adjusted such that the final cured coating is effective in suppressing noise and vibration transmission to the desired extent. In many instances, the compositions may be applied to a wet film thickness of from 1 to 5 mm. The application of thinner layers within this range is more economical and provides for a reduced likelihood of deleterious thick cured regions. However, great control must be exercised in applying thinner coatings or layers to avoid the formation of discontinuous cured films.

The curing of the compositions of the invention typically occurs at room temperatures or at a temperature in the range of from 10° C. to 50° C., preferably from 20° C. to 30° C. The temperature that is suitable depends on the specific compounds present and the desired curing rate and can be determined in the individual case by the skilled artisan, using simple preliminary tests if necessary.

It is understood that all embodiments disclosed herein in relation to the methods are similarly applicable to the disclosed dispersions, compositions, and uses and vice versa.

### LISTING OF EMBODIMENTS

1. A sprayable aqueous acoustic damping composition comprises:
   a) 0.1-0.75 parts by weight of a water-soluble cellulose compound or a water-soluble starch,
   b) 10 to 35 parts by weight of a polymer,
   c) 15 to 30 parts by weight of water;
   d) 20 to 45 parts by weight of a filler;
   wherein, the filler comprising a filler (i) with an average particle size (d₅₀ particle size) of about 7-18 μm and a filler (ii) with an average particle size (d₅₀ particle size) of about 2-5 μm.
2. The composition according to embodiment 1, wherein the water-soluble cellulose compound comprising at least a water-soluble cellulose derivative selected from cellulose ether, cellulose salt, or combination thereof.
3. The composition according to any one of preceding embodiments, wherein the content of the water-soluble cellulose compound or the water-soluble starch is 0.2 to 0.5 parts by weight in the composition.
4. The composition according to any one of preceding embodiments, wherein the polymer comprising one or more selected from acrylic polymer (including co-polymer), styrene-acrylic copolymer, styrene-butadiene copolymer, vinyl acetate (including but not limited to polyvinyl acetate (“PVAc”) and ethylene vinyl acetate (“EVA”) copolymer), vinyl-acrylic copolymer and the like.
5. The composition according to any one of preceding embodiments, wherein the polymer comprises styrene-butadiene polymer, acrylic polymer, acrylic ester polymer, ethylene-vinyl acetate polymer, and mixtures thereof.
6. The composition according to any one of preceding embodiments, wherein the polymer content is 20-30 parts by weight in the composition.
7. The composition according to any one of preceding embodiments, wherein the filler is selected from the group consisting of calcium carbonate, barium sulfate, zinc oxide, aluminum oxide, titanium dioxide, aluminum hydroxide, talcum powder or any combination thereof.
8. The composition according to any one of preceding embodiments, wherein the weight ratio of the filler (i) to the filler (ii) is from 1.9:1 to 4:1, preferably from 2:1 to 2.9:1.
9. The composition according to any one of preceding embodiments, wherein the composition further comprises from 0.02 to 2 parts by weight of a defoamer.
10. The composition according to any one of preceding embodiments, wherein the composition further comprises from 5 to 11 parts by weight of a mica.
11. The composition according to any one of preceding embodiments, wherein the water content is 20-30 parts by weight in the composition.
12. The composition according to any one of preceding embodiments, wherein the composition doesn't comprise fumed silica as thixotropic agent.
13. Use of the sprayable aqueous acoustic damping composition as defined in any one of embodiments 1 to 12 as a liquid applied sound damping composition.
14. An article includes an aqueous acoustic damping composition on a surface of the article, wherein the aqueous acoustic damping composition is a cured product of the sprayable aqueous acoustic damping composition of anyone of embodiments 1-12.
15. A method of preparing a coated substrate, said method comprising:
   c) applying a sprayable aqueous acoustic damping composition as defined in any one of embodiments 1 to 12 to at least a surface of a substrate by spraying; and,
   d) curing the composition at 10-50° C. preferably at 20-30° C.
16. A vehicle component obtained by the method as defined in embodiment 15.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Raw Materials

| Product name | Description/function | Source |
|---|---|---|
| Xanthan gum | Polysaccharide | CP Kelco |
| Corn Starch | water-soluble starch | Sanstar Bio-Polymers |
| CMC 75 A Powder | Sodium carboxymethyl cellulose | Mikro Technik |
| Natrosol 250 HHR | Hydroxyethylcellulose | Ashland Inc |
| Acronal 3612 | 55.1% solids by wt. acrylic polymer emulsion | BASF SE |
| Wantipro 0618 | 50% solids by wt. Polyacrylate emulsion | Wanghua |
| Acousticryl SD-55 | 47.5% solids by wt. acrylic copolymer | Dow Chemical |
| | emulsion | |
| 1220v | 50% water, styrene-acrylic emulsion | Dow Chemical |
| Orotan N-4045 | Dispersant, 2-Propenoic acid, homopolymer, | Dow Chemical |
| | sodium salt | |
| Acticide MBS | Bactericide | Thor Chemie |
| Anticide CS | Bactericide | Thor Chemie |
| Mica GM 3 | Mica, D₅₀ ≤18 μm | ChuZhou Grea Minerals |
| Mica GM 2 | Mica, D₅₀ ≤24 μm | ChuZhou Grea Minerals |
| Foamaster MO NXZ | Defoaming agent | BASF |
| Omyacarb 2 QY | Ground calcium carbonate, D₅₀ ~2.9 μm | Omya |
| | | (QY = Qingyang, China) |
| FA082 | aluminum hydroxide, D₅₀ ~20 μm | Foshan Jin'ge Material |
| Apyral 8 | aluminum hydroxide, D₅₀ ~14.9 μm | NABALTEC AG |
| Hydrated alumina 12 | aluminum hydroxide, D₅₀ ~10 μm | Ji'nan Chenxu |
| 50 mesh | | |
| Aluminum hydroxide | aluminum hydroxide, D₅₀ ~5 μm | Guangzhou Shinshi |
| SH 820 | | Metallurgy |
| Graphite K 500 | carbon black, D₅₀ ~6.5 μm | Changzhou Herun New |
| | | Materials |
| AEROSIL 300 | fumed silica (BET 300) | Evonik |
| HDK H18 | fumed silica (BET about 200) | Wacker |

* All raw materials are directly used without any special treatment.

### Example 1

### <Preparation of Sprayable Aqueous Acoustic Damping Composition>

For the preparation of sprayable aqueous acoustic damping composition E1, polymer emulsion, dispersing agent, bactericide, filler, Natrosol 250 HHR and CMC 75 A Powder were added into a container and mixed by PC lab mixer at 200-500 r/min until all the material was saturated. Then, mixed by PC lab mixer at 600-900 r/min for 40 mins under 35° C. Later, charged Graphite K 500, mixed by Speedmixer at 200-500 r/min until saturated. Then, mixed at 600-900 r/min for 40 mins under 35° C. Later, mixed under vacuum 40 mbar at 600-900 r/min for 60 mins. Then check the particles size to finalize this batch.

### <Curing of Aqueous Acoustic Damping Composition>

The compositions were applied to the substrate by spraying with the power line II gun and widespread nozzle. The thickness was controlled from about 1 mm to about 5 mm (e.g., from about 2 to about 4 mm). After application on the substrate, the composition was cured at room temperature (25° C.) for at least about 10 minutes, more typically from about 6 hours to about 12 hours.

### Example 2-11, and CE1-CE9

The sprayable aqueous acoustic damping compositions of E2 to E11, CE1 to CE7 were prepared in reference to Example 1. The aqueous acoustic damping composition of E2 to E11 and CE1 to CE7 were cured in reference to Example 1. More details are listed in below result part.

### Test Methods

### Viscosity

When measured the viscosity of the sprayable aqueous acoustic damping composition after preparation, the dynamic viscosity was measured using an Anton Paar MCR 302 rheometer with a 25 mm diameter parallel disc rotor, an oscillation frequency of 1 Hz, and an amplitude of 0.3% and a rheometer disc temperature of 25° C. and a shear rate of 1 s⁻¹, the viscosity is recorded as Viscosity @ 1 s⁻¹.

“High shear viscosity” was measured using an Anton Paar MCR 302 rheometer with a gap of 0.5 mm at 25° C. and a shear rate of 100 s⁻¹, viscosity is recorded as Viscosity @ 100 s⁻¹.

“Low shear viscosity” was measured using an Anton Paar MCR 302 rheometer with a gap of 0.5 mm at 25° C. and a shear rate of 1 s-after high shearing test, the viscosity is recorded as Viscosity @ 1 s⁻¹ (after high shearing test).

The thixotropic index (TI) is a measure of the shear-dependent properties and can be defined as the ratio of viscosities measured at a certain lower shear rate to viscosities measured at a certain higher shear rate. As used herein, TI is the ratio of Viscosity @ 1 s⁻¹ (after high shearing test) to Viscosity @ 100 s⁻¹.

### Phase Separation

The composition was down filled in the aluminum cartridges and the total package was made up with cartridge, plug and cap. Then the cartridges were used to implement the phase separation test by method a), below.
a) store at room temperature (environment temperature 5-35° C.) for at least 3 months, then quickly check whether there is water condensation at the space between plug and cap.

### Acoustic Damping

The curing of the sound deadener composition for damping test may comprise steps of:
a) exposing the sound deadener composition to room condition for 1-4 hours;
b) heating the sound deadener composition for 2-6 hours at a temperature range from 40 to 80° C.; and
c) cooling the sound deadener composition and allowing the sound deadener to cure for 5 to 10 days at room temperature.
A loss factor of the cured product of the sound deadener composition in the present invention may be measured according to GB/T 16406.

### Appearance (Crack Check)

Check the appearance of samples after curing.

Appearance test results are recorded and ranked as follows:
Yes: Crack
No: No crack.

TABLE 1

| | E1 | E2 | E3 | E4 | E5 | E6 | E7 | E8 | E9 | E10 | E11 |
|---|---|---|---|---|---|---|---|---|---|---|---|
| Corn Starch | | | | | | | | | 0.35 | | |
| CMC 75 A pwdr | 0.15 | 0.15 | 0.15 | 0.15 | 0.15 | 0.15 | | 0.35 | | 0.15 | 0.15 |
| Natrosol 250 | 0.2 | 0.2 | 0.2 | 0.2 | 0.2 | 0.2 | 0.35 | | | 0.2 | 0.2 |
| HHR | | | | | | | | | | | |
| Acronal 3612 | | 25 | 25 | 36.5 | 36.5 | 36.5 | 36.5 | 36.5 | 36.5 | 25 | 25 |
| Wanna 0618 | 25 | | | | | | | | | | |
| Acousticryl SD | 25 | | 25 | 11.5 | 11.5 | 11.5 | 11.5 | 11.5 | 11.5 | 25 | 25 |
| 55 | | | | | | | | | | | |
| 1220v | | 25 | | | | | | | | | |
| Orotan N 4045 | 1.2 | 1.2 | 1.2 | 1.2 | 1.2 | 1.2 | 1.2 | 1.2 | 1.2 | 1.2 | 1.2 |
| Acticide MBS | 0.25 | 0.25 | 0.25 | 0.25 | 0.25 | 0.25 | 0.25 | 0.25 | 0.25 | 0.25 | 0.25 |
| Anticide CS | 0.1 | 0.1 | 0.1 | 0.1 | 0.1 | 0.1 | 0.1 | 0.1 | 0.1 | 0.1 | 0.1 |
| Mica GM 3 | 10 | 12 | 10 | 10 | | | | | | | |
| Mica GM 2 | | | | | 10 | 10 | 10 | 10 | 10 | | |
| Foamaster MO | 0.1 | 0.1 | 0.1 | 0.1 | 0.1 | 0.1 | 0.1 | 0.1 | 0.1 | 0.1 | 0.1 |
| NXZ | | | | | | | | | | | |
| Omyacarb 2 QY | 11 | 11 | 11 | 11 | 11 | 11 | 11 | 11 | 11 | 11 | |
| Apyral 8 | | | | | | 22 | 22 | 22 | 22 | | |
| Hydrated Al2O3 | 22 | 22 | 22 | 22 | 22 | | | | | 32 | 32 |
| 1250 mesh | | | | | | | | | | | |
| Al hydroxide SH | | | | | | | | | | | 11 |
| 820 | | | | | | | | | | | |
| Graphite K 500 | 3 | 3 | 3 | 3 | 3 | 3 | 3 | 3 | 3 | 3 | 3 |
| Total | 98 | 100 | 98 | 96 | 96 | 96 | 96 | 96 | 96 | 98 | 98 |
| Water content | 25.6 | 23.8 | 24.4 | 22.5 | 22.5 | 22.5 | 22.5 | 22.5 | 22.5 | 24.4 | 24.4 |

Table 1 shows compositions of the sprayable aqueous acoustic damping compositions E1-E11.

TABLE 2

| | E1 | E2 | E3 | E4 | E5 | E6 | E7 | E8 | E9 | E10 | E11 |
|---|---|---|---|---|---|---|---|---|---|---|---|
| Phase | No | No | No | No | No | No | No | No | No | No | No |
| Separation | | | | | | | | | | | |
| Viscosity | 337 | 389.3 | 363 | 264 | 313 | 304 | 325 | 310 | 274 | 235 | 345 |
| @ 1 s⁻¹ | | | | | | | | | | | |
| (Pa · s) | | | | | | | | | | | |
| Viscosity | 8.9 | 11.47 | 9.2 | 6 | 6.9 | 8.3 | 7.6 | 7.1 | 6.5 | 5.6 | 7.6 |
| @ 100 s⁻¹ | | | | | | | | | | | |
| (Pa · s) | | | | | | | | | | | |
| Viscosity | 301 | 280 | 323 | 203 | 237 | 256 | 247 | 223 | 196 | 218 | 302 |
| @ 1 s⁻¹ | | | | | | | | | | | |
| (After | | | | | | | | | | | |
| high | | | | | | | | | | | |
| shearing | | | | | | | | | | | |
| test) | | | | | | | | | | | |
| (Pa · s) | | | | | | | | | | | |
| TI value | 33.82 | 24.41 | 35.11 | 33.83 | 34.35 | 30.84 | 32.50 | 31.41 | 30.15 | 38.93 | 39.74 |
| Crack | No | No | No | No | No | No | No | No | No | No | No |

Table 2 shows testing results of the sprayable aqueous acoustic damping compositions E1-E11.

TABLE 3

| | CE1 | CE2 | CE3 | CE4 | CE5 | CE6 | CE7 |
|---|---|---|---|---|---|---|---|
| Xanthan gum | | | | | 0.1 | 0.2 | |
| CMC 75 A Powder | | 0.15 | 0.15 | | 0.15 | | 0.4 |
| Natrosol 250 HHR | | 0.2 | 0.2 | | 0.2 | | 0.6 |
| Acronal 3612 | 25 | 25 | 25 | 25 | 25 | 25 | 36.5 |
| Acousticryl SD 55 | 25 | 25 | 25 | 25 | 25 | 25 | 11.5 |
| Orotan N 4045 | 1.1 | 1.2 | 1.1 | 1.2 | 1.2 | 1.1 | 1.2 |
| Acticide MBS | 0.25 | 0.25 | 0.25 | 0.25 | 0.25 | 0.25 | 0.25 |
| Anticide CS | 0.1 | 0.1 | 0.1 | 0.1 | 0.1 | 0.1 | 0.1 |
| Mica GM 3 | 6.6 | 10 | 6.6 | 10 | 10 | 6.6 | 10 |
| Foamaster MO NXZ | 0.1 | 0.1 | 0.1 | 0.1 | 0.1 | 0.1 | 0.1 |
| Omyacarb 2 QY | 11 | 11 | 11 | 11 | 11 | 11 | 11 |
| FA082 | | 22 | | | | | |
| Apyral 8 | | | | | | | |
| Hydrated alumina | | | | 22 | 22 | | 22 |
| 1250 mesh | | | | | | | |
| Aluminum | 22 | | 22 | | | 22 | |
| hydroxide SH 820 | | | | | | | |
| Graphite K 500 | 8.3 | 3 | 8.3 | 3 | 3 | 8.3 | 3 |
| AEROSIL 300 | 0.55 | | 0.55 | | | 0.55 | |
| HDK H18 | | | | 0.6 | | | |
| Total | 100 | 98 | 100.35 | 98.25 | 98.1 | 100.2 | 96.65 |
| Water content | 24.4 | 24.4 | 24.4 | 24.4 | 24.4 | 24.4 | 22.5 |

Table 3 shows compositions of the comparative sprayable aqueous acoustic damping compositions CE1-CE7.

TABLE 4

| | CE1 | CE2 | CE3 | CE4 | CE5 | CE6 | CE7 |
|---|---|---|---|---|---|---|---|
| Phase Separation | No | No | No | Yes | No | Yes | No |
| Viscosity @ 1 s⁻¹ | 220 | 280 | 257 | 47 | 312 | 333 | 1327 |
| Viscosity @ 100 s⁻¹ | 7.5 | 7.1 | 8.6 | 2.6 | 7.2 | 9.2 | 27.1 |
| (<10 Pa is preferred) | | | | | | | |
| Viscosity @ 1 s⁻¹ | 150 | 247 | 217 | 24.29 | 210 | 129 | 767 |
| (After high shearing test) | | | | | | | |
| TI value | 20 | 34.79 | 25.23 | 9.34 | 29.17 | 14.02 | 28.30 |
| Crack | Yes | Yes | Yes | No | Yes | Yes | NA |

Table 4 shows testing results of the comparative sprayable aqueous acoustic damping compositions CE1-CE7.

It can be seen that the sprayable aqueous acoustic damping composition of E1 to E11 provides good stability without phase separation. In addition, the cured products of sprayable aqueous acoustic damping compositions of E1 to E11 provide good acoustic damping performance (loss factor is greater than 0.1 @ 20° C., 200 Hz, while the thickness of damping film is 2.3 mm), have special surface texture, and good anti-crack property. The sprayable aqueous acoustic damping composition of E2 has higher Viscosity @ 100 s⁻¹, due to high level of mica in the composition, the composition may need an additional 5-10 mins of heating process before spray application at room temperature.

Sprayable aqueous acoustic damping compositions of CE1-CE3 have cracks on the surface. CE1 doesn't comprise water-soluble cellulose compound or filler (i). CE2 comprises filler with D50 of 20 μm and water-soluble cellulose compound. CE3 comprises water-soluble cellulose compound, but no filler (i). Without water-soluble cellulose compound, filler (i) and filler (ii), the compositions show bad anti-crack property.

CE4 comprises filler (i), filler (ii) and fumed silica, but no water-soluble cellulose compound. Phase separation takes place in the composition of CE3. The cured LASD product doesn't have special surface texture.

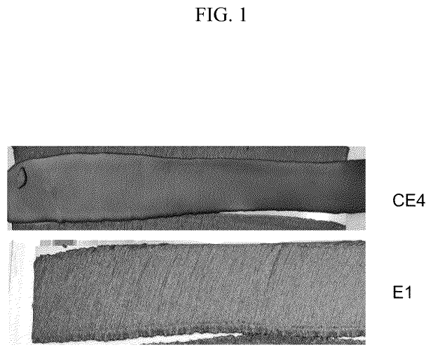

FIG. 1 shows the appearance of cured compositions of the sprayable aqueous acoustic damping composition of E1 and CE4. It can be seen that the aqueous acoustic damping composition of CE4 has a TI value of less than 10.0, and produced LASD product has a smooth surface. And the aqueous acoustic damping composition of E1 has a high thixotropic index (greater than 15) and produced LASD product has special surface texture.

CE5 comprises another water-soluble polysaccharide compound, xanthan gum. It can be seen from the comparison of E5 and CE5, the cured composition with xanthan gum is brittle and has cracks on the surface.

The composition of CE7 comprises excess amount of water-soluble cellulose compound, the viscosity of the composition is too high to operate. It can be observed that the suitable amount of the cellulose compound is less than 1.0 parts by weight in the total composition.

What is claimed is:

1. A sprayable aqueous acoustic damping composition comprises:
a) 0.1-0.75 parts by weight of a water-soluble cellulose compound or a water-soluble starch,
b) 10 to 35 parts by weight of a polymer,
c) 15 to 30 parts by weight of water;
d) 20 to 45 parts by weight of a filler;
wherein, the filler comprising a filler (i) with an average particle size (d₅₀ particle size) of about 7-18 μm and a filler (ii) with an average particle size (d₅₀ particle size) of about 2-5 μm.

2. The composition according to claim 1, wherein the water-soluble cellulose compound comprising at least a water-soluble cellulose derivative selected from cellulose ether, cellulose salt, or combination thereof.

3. The composition according to claim 1, wherein the content of the water-soluble cellulose compound or the water-soluble starch is 0.2 to 0.5 parts by weight in the composition.

4. The composition according to claim 1, wherein the polymer comprising one or more selected from acrylic polymer (including co-polymer), styrene-acrylic copolymer, styrene-butadiene copolymer, vinyl acetate (including but not limited to polyvinyl acetate (“PVAc”) and ethylene vinyl acetate (“EVA”) copolymer), vinyl-acrylic copolymer and the like.

5. The composition according to claim 1, wherein the polymer comprises styrene-butadiene polymer, acrylic polymer, acrylic ester polymer, ethylene-vinyl acetate polymer, and mixtures thereof.

6. The composition according to claim 1, wherein the polymer content is 20-30 parts by weight in the composition.

7. The composition according to claim 1, wherein the filler is selected from the group consisting of calcium carbonate, barium sulfate, zinc oxide, aluminum oxide, titanium dioxide, aluminum hydroxide, talcum powder or any combination thereof.

8. The composition according to claim 1, wherein the filler (d) has a weight ratio of the filler (i) to the filler (ii) of from 1.9:1 to 4:1.

9. The composition according to claim 1, wherein the composition further comprises from 0.02 to 2 parts by weight of a defoamer.

10. The composition according to claim 1, wherein the composition further comprises from 5 to 11 parts by weight of a mica.

11. The composition according to claim 1, wherein the water content is 20-30 parts by weight in the composition.

12. The composition according to claim 1, wherein the composition doesn't comprise fumed silica as thixotropic agent.

13. The composition according to claim 11, wherein the composition is a liquid applied sound damping composition having a weight ratio of the filler (i) to the filler (ii) of from 2.1:1 to 2.9:1.

14. An article comprising an aqueous acoustic damping composition on a surface of the article, wherein the aqueous acoustic damping composition is a cured product of the sprayable aqueous acoustic damping composition of claim 1.

15. A method of preparing a coated substrate, said method comprising:
a) applying a sprayable aqueous acoustic damping composition as defined in claim 1 to at least a surface of a substrate by spraying; and,
b) curing the composition at 10-50° C.

16. A vehicle component obtained by the method as defined in claim 15.
